(19) United States
(12) Patent Application Publication
(10) Pub. No.: US 2004/0151481 A1
(43) Pub. Date: Aug. 5, 2004

(54) Apparatus for the heat sealing of thermoplastic packagings or wrappings

(76) Inventors: Stefano Cassoli, Casalecchio Di Reno (IT); Giordano Gorrieri, Pianoro (IT); Giorgio Bonafe, Casalecchio Di Reno (IT); Catena Rosa, Casalecchio Di Reno (IT)

Correspondence Address: STITES & HARBISON PLLC, 1199 NORTH FAIRFAX STREET, SUITE 900, ALEXANDRIA, VA, 22314, US

(21) Appl. No.: 10/474,900

(22) PCT Filed: Apr. 19, 2002
(86) PCT No.: PCT/EP02/04346

(30) Foreign Application Priority Data
Apr. 23, 2001 (IT) BO2001 A 000242

(51) Int. Cl. A61H 33/08; F24H 3/02

(52) U.S. Cl. 392/379

(57) ABSTRACT

The apparatus comprises a pair of parallel conveyors (T1, T1′) with vertical motorized axes (101, 101′), formed by any flexible heat-resistant and air-permeable structure, the inside run of which contacts with appropriate pressure the sides, containing the folded-down flaps to be sealed, of the packaging (P), which is supported from beneath by for example an optional horizontal motorized conveyor (T) travelling in the same direction and at the same speed as the said inside runs of the said lateral conveyors arranged longitudinally behind which are tubular electrical resistors (6, 6′) heatable by the joule effect and of low thermal inertia, that dispense jets of hot air through the active inside runs of these conveyors and that are incident upon the flaps of the packagings, in order to produce weld lines thereon. Subsequent means (10, 10′) are provided to maintain an appropriate pressure and to cool the said weld lines, before the packagings leave the said apparatus.

The invention finds industrial application in machines for packaging with heat-sealable plastic film, such as polyethylene or polypropylene, sets of rolls of paper, such as toilet rolls or kitchen towels, and for these machines proposes a novel apparatus for heat sealing the folded-down flaps of the said packagings on a continuous cycle. It will be understood however that the present apparatus must be understood as being protected for any other use for which it may be suitable, apart from that indicated above.

In order to explain more clearly the objects of the proposed invention, it will be helpful briefly to recall that in these machines, the packagings are usually inserted in single file, by rear pushing means, between the inner runs of two parallel vertical-axes conveyors made from PTFE-based belts moving in the same direction and at the same speed as a horizontal conveyor on which the packagings are carried. That face of each vertical-axis conveyor which is not in contact with the folded-down flaps of the said packagings slides first over heating units which seal the said flaps and then slides over cooling units which remove heat from the sealed flaps and stabilize then in the stuck-together condition, before the packagings leave the said apparatus.

This apparatus draws considerable electrical power, which remains at a constant level even in the dimensions of the packagings are reduced, exhibit a very high thermal inertia which causes considerable problems when starting and stopping the machine, and have PTFE-coated conveyors which move with sliding friction over the heating and cooling units, which are subject to considerable wear and which must be periodically replaced. Another drawback with the known apparatus is that the periphery parts of the packagings that come into contact with the heating unit, but have no packaged material to remove some of the heat, tend to overheat and break, which obviously causes problems with the quality of the resulting heat weld.

It is an object of the invention to overcome these and other drawbacks of the prior art by proposing the following solution. In the heat-sealing of thermoplastic films and sheets, where welds are made with heated bars, it is prior art to use electrical strip resistors, usually packaged in thin narrow envelopes or jackets of nonstick material, usually PTFE-based, characterized by practically zero thermal inertia, the ends of which strips are connected to an electric circuit by which they can be heated by the Joule effect and can be electronically temperature-controlled by controlling the parameters of the electrical current drawn. In relatively recent times, using material of the same type as that used for the said strips, tubular electrical resistors of low thermal inertia have been successfully produced: these are heated by the Joule effect and compressed air is passed through them. The folded-down flaps of the packaging that is to be sealed are conveyed past a resistor of this kind which heats the said flaps by both conduction and radiation, emitting jets of hot air which soften or “plasticize” those parts of the said flaps on which they are incident, thereby preparing them for welding. A welder of this type is described for example in U.S. Pat. No. 6,134,387 (Toss).

The invention provides a continuous-sealing apparatus as a replacement for the known kind cited in the introduction to this description, which, in the place of the radiant heating unit, uses sources of hot air of the abovementioned type, which can exert their action through mesh-type PTFE-coated conveyors or through the open gaps in parallel-belt conveyors. The parts of the packaging moving away from the action of the hot-air sources are locked and stabilized by jets of cold air and/or by contact with cooled motorized conveying belts applying appropriate pressure to the said parts.

Other characteristics of the invention, and the advantages procured thereby, will be made clearer in the following description of certain preferred embodiments and uses thereof, illustrated purely by way of non-limiting examples, in the figures of the attached sheets of drawings, in which:

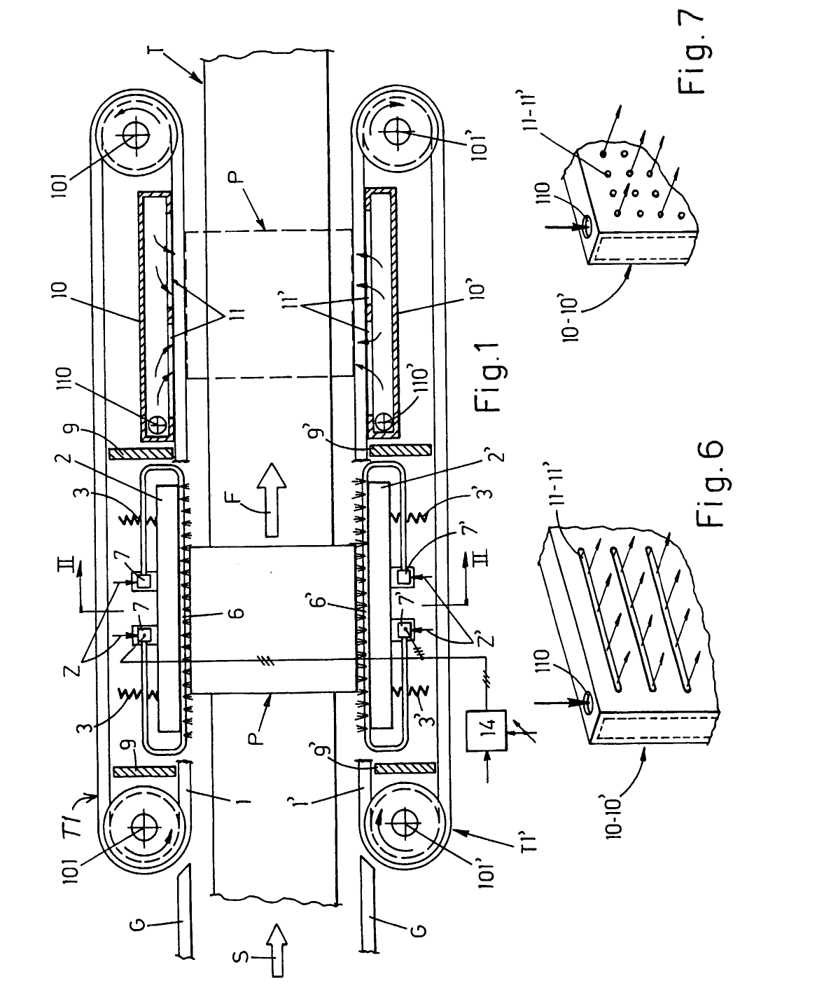

FIG. 1 is a schematic plan view from above of the apparatus according to the invention;

FIG. 1a illustrates schematically and in plan view an alternative construction of the apparatus;

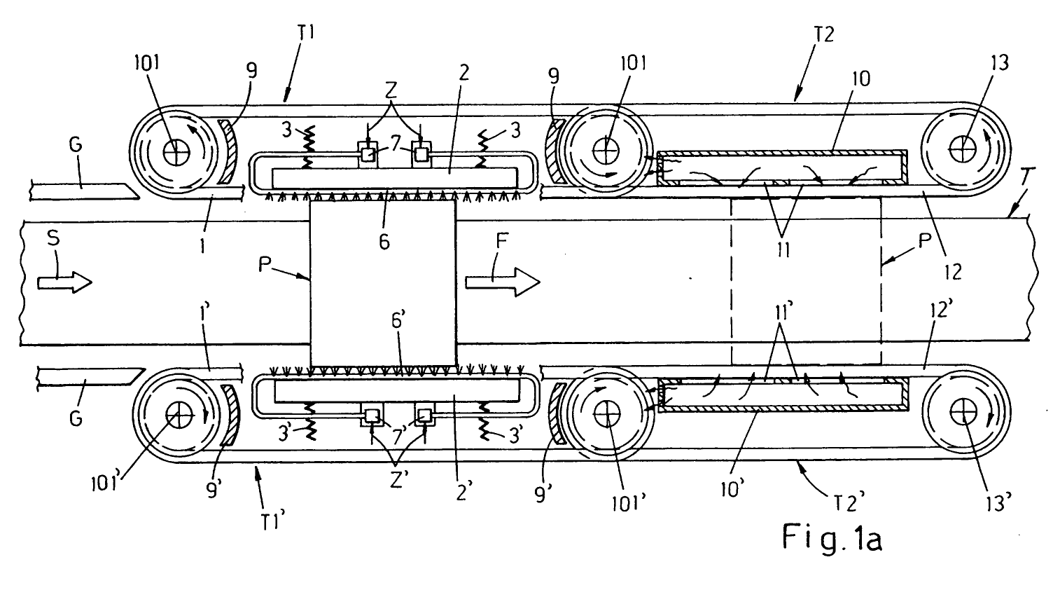

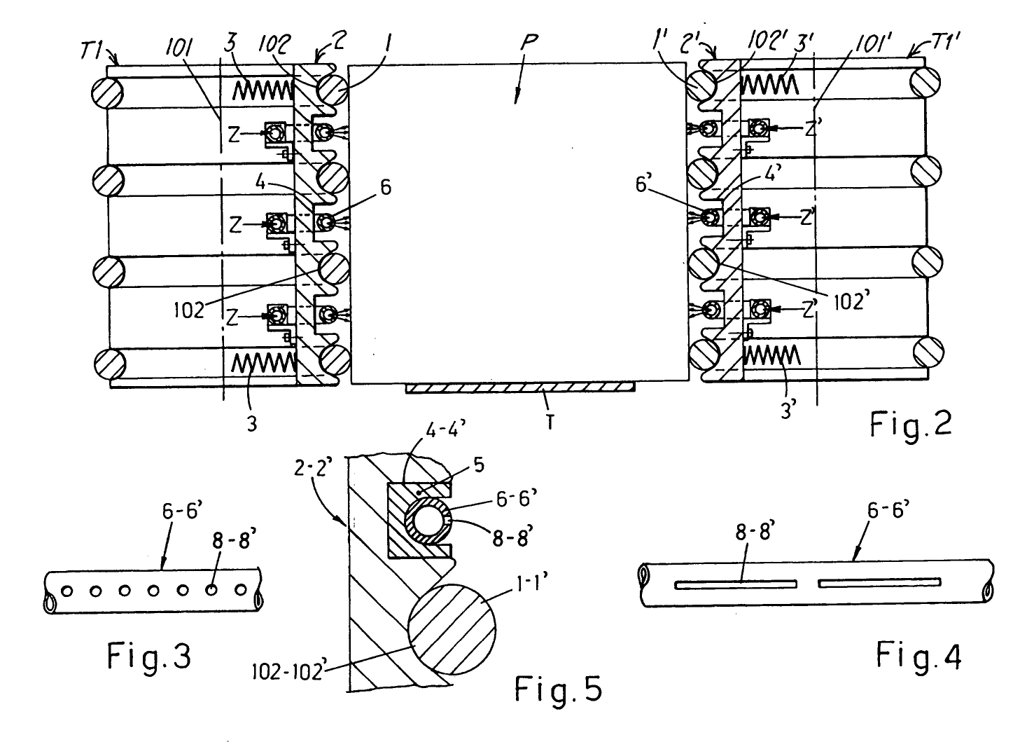

FIG. 2 shows details revealed by cross section II-II marked in FIG. 1;

FIGS. 3 and 4 illustrate schematically some possible embodiments of the hot-air outlet apertures of the electrical resistors of the heat-sealing unit of the apparatus;

FIG. 5 shows an alternative construction of the apparatus, viewed on the same cross-sectional line II-II marked in FIG. 1;

FIGS. 6 and 7 illustrate schematically and in perspective two possible embodiments of the compressed-air cooling unit;

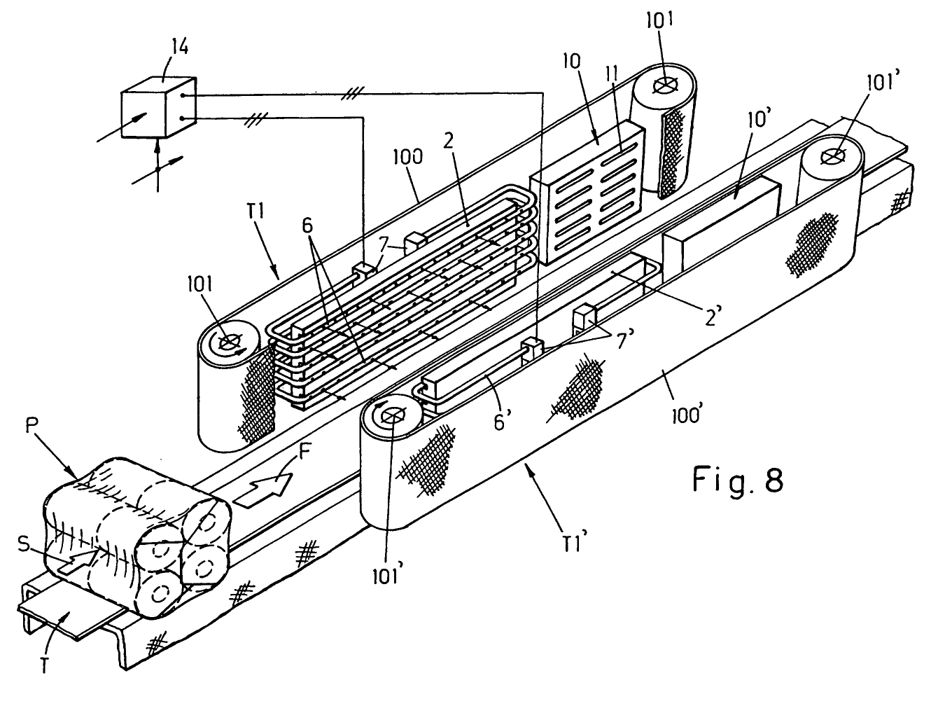

FIG. 8 is a perspective view of an alternative construction of the invention.

Referring to FIGS. 1 and 2, it will be seen that the packagings P exiting the forming machine, pushed from behind by a known pusher S and optionally guided on either side by the fixed guides G while being supported from beneath by a horizontal conveyor T travelling in the same direction F of advance as the said pusher, leave behind the said guides and their folded-down side flaps, which are to be sealed, come into contact with a pair of conveyors T1, T1 travelling around vertical axes 101, 101′, all or some of which are motorized in such a way that the inside run of the conveyors travels in the same direction of movement F as the lower conveyor T and at the same speed. In a preferred embodiment, the conveyors T1, T1′ are made up of parallel belts 1, 1 spaced apart from each other in the vertical direction, optionally of round cross section and preferably made of a material that is a poor conductor of heat and/or has a low thermal inertia.

For an initial section of the inside run of the conveyors T1, T1′, the belts 1, 1′ are travelling, and in part housed, partly to protect them from the heat (see below), in the straight grooves 102, 102′ formed in vertical guide bodies 2, 2′ made preferably from a material with a good degree of thermal and electrical insulation. These bodies are mounted on the support frame of the said conveyors T1, T1′ and are optionally subject to the action of having a guiding and elastic means and/or positioning function 3, 3′ that push these bodies and the associated section of the belts towards each other in order to appropriately grip the interposed packaging P and ensure that it is subject to the conveying action of these belts 1, 1′. Suitable means (not shown) are provided to vary the distance between the conveyors T1, T1′ and associated parts to adapt to different dimensions of the packagings being sealed, in much the same way as occurs in known machines.

In the space between the belts 1, 1′, the guide bodies 2, 2′ include straight recesses 4, 4′ parallel with the said belts. These house directly, with sufficient play as in FIG. 2 or with intermediate channels 5 made of a material with high levels of thermal insulation and also with supporting functions as in FIG. 5, a number of heating units 6, 6′ which may for example be made of straight tubular electrical resistors of low thermal inertia, of the type cited in the introduction to this description, the resistors being heated by the Joule effect and being wrapped and attached at each end to terminals 7, 7′ attached to, for example, the rear face of the bodies 2, 2′, for connection to the electrical power sources and to one or more sources of compressed air, as schematically indicated by the arrows Z, Z′.

The active straight runs of the resistors 6, 6′ positioned between the active runs of the belts 1, 1′ are suitably set back from the surface with which the said belts 1, 1′ contact and convey the packaging P to be sealed, and as illustrated in the detail in FIGS. 3 and 4, these active runs of the resistors contain, along some or all of their length, small holes or apertures 8, 8′ that form nozzles facing the packaging to be sealed, so as to direct pressurized jets of hot air at the latter. Under the action of the radiant heat produced by the resistors 6, 6′ and under the action of the jets of hot air exhausted by the small nozzles 8, 8′ of the same resistors, the portions of the folded-down flaps of the packaging between the conveyor belts 1, 1′ are subjected to the necessary temperature and pressure to bond them together along weld lines.

Reference numbers 9, 9′ denote barriers of poor heat-conducting material insulating the heating units from the adjacent areas, particularly from the adjacent cooling units, which take the form of chambers 10, 10′ positioned between the conveyors T1, T1′ and preferably operate in contact with the belts 1, 1′ to extract the heat from them by conduction. The chambers have at least one orifice 110, 110′ for connection to a source supplying compressed air, either chilled or at room temperature, and they also have apertures or holes 11, 11′, at least in the areas between the said belts, to distribute corresponding jets of cool air under pressure against the welded parts of the packagings in order to stabilize them and lock them before the packagings are released. The nozzles 11, 11′ may if desired also be directed at the belts 1, 1′ in order to cool them more effectively.

In the variant illustrated in FIG. 1a, the length of the belt conveyors T1, T1′ is limited to containing the hot-air heating units, while the axes 101, 101′ at the outlet ends of these conveyors also carry the PTFE-coated belts 12, 12′ of another set of conveyors T2, T2′. The latter pass around final vertical axes and may also be motorized 13, 13′, and their inside runs operate in combination with cooling units, e.g. of known type or of the type shown in FIG. 1, designed optionally to also cool the belts 1, 1′ as they pass around the outlet axes 101, 101′. The whole arrangement is such that these belts 12, 12′ are in contact with the welded parts so as to apply mechanical pressure to them and bring about faster, more direct heat extraction.

To accommodate different dimensions of packagings to be sealed, means (not shown) are provided to adjust the distance between the conveyors T1, T1′ and between the optionally conveyors T2, T2′, and means are provided to activate the heating units 6, 6′ in a number proportional to the dimensions of the packagings. For this purpose the electrical resistors 6, 6′ may be connected to a supply and control unit 14 as in FIG. 1, which controls their temperature by varying the electric current in relation to variations in resistance, and which can also be used to select which resistors should be active and which should remain inactive. The low thermal inertia of the resistors employed will avoid problems in the event of sudden stoppage of the apparatus. In such a case, some of the means indicated schematically at 3 and 3′ may optionally be enabled to retract the heating units 2, 6, 2′, 6′ as appropriate from the active runs of the conveyors T1, T1 and hence from the path of the packagings undergoing sealing.

Lastly, suitable means may be provided to modify the relative heights of the parts T1, T1′, (T2, T2′) and T in response to different dimensions of packagings to be sealed, so that the packagings are always correctly central relative to the activated electrical resistors.

FIG. 8 shows a variant of the solution shown in FIG. 1: here, the vertical-axe conveyors T1, T1′ are not belt type but formed instead from mesh webs 100, 100′ of heat-resistant material that is nonstick with respect to the plastic material of the packagings. These have the dual function of correctly gripping the flaps of the said packagings while the latter are receiving the hot air passing through the mesh structure of the webs themselves. The active runs of the mesh-web conveyors pass first over the pressure structures 2, 2′ while the hot air generated by the electrical resistors 6, 6′ is blown through them, and then pass over the cooling units 10, 10′, which are of the type described or of conventional type.

1. Apparatus with low-thermal-inertia hot-air sealing unit, for the heat sealing of the folded-down flaps of thermoplastic packagings or wrappings, such as packagings of rolls of paper or other paper-based products, the apparatus being characterized in that it comprises a pair of parallel conveyors (T1, T1′) with vertical motorized axes (101, 101′), formed by any flexible heat-resistant and air-permeable structure, the inside run of which contacts with appropriate pressure the sides, containing the folded-down flaps to be sealed, of the packaging (P), which is supported from beneath by for example an optional horizontal motorized conveyor (T) travelling in the same direction and at the same speed as the inside runs of the said lateral conveyors arranged longitudinally behind which are units (6, 6′) that emit jets of hot air that pass through the active inside runs of these vertical conveyors and are incident upon the flaps of the packagings, in order to produce weld lines thereon, means being provided to maintain an appropriate pressure and to cool these weld lines, before the packagings leave the said apparatus.

2. Apparatus according to claim 1, in which the vertical-axis conveyors (T1, T1′) are formed by a plurality of parallel belts (1, 1′) suitably spaced out from each other in the vertical direction, the said heating units (6, 6′) being positioned parallel and in a set-back position in the empty spaces of the active inside runs of the said belt conveyors, in such a way that the hot air generated by the said units passes through the said empty spaces and is directly incident upon the flaps of the packagings to be sealed.

3. Apparatus according to claim 2, in which the said belts (1, 1′) are made of materials with a high degree of thermal insulation and/or low thermal inertia.

4. Apparatus according to claim 1, in which the units (6, 6′) that produce the jets of hot air are tubular-shaped electrical resistors of low thermal inertia heatable by the Joule effect and temperature-controllable by controlling their resistance and by varying the electrical current drawn, these resistors being connected to at least one source of compressed air and being provided, on the active straight parallel runs suitably set back from the active runs of the conveying belts (1, 1′), with small holes or apertures (8, 8′) for exhausting the hot air at the flaps of the packaging that is to be sealed.

5. Apparatus according to claim 4, in which that section of the active run of each of the said belts (1, 1′) that passes in front of the electrical resistors (6, 6′) where the hot-air jets are produced, travels in straight protective guide slots (102, 102′) in vertical bodies (2, 2′) which are preferably made of a material with a high degree of thermal and electrical insulation and are attached to the support frame of the conveyors (T1, T1′) with the said belts, with the optional interposition of means having a guiding and elastic and/or positioning function (3, 3′) that keep the said belts at an appropriate contact pressure against the packagings being conveyed and sealed.

6. Apparatus according to claim 5, in which the said means (3, 3′) having a guiding and/or positioning function may be such that, in the event of sudden stoppage of the sealing system, the electrical resistors (6, 6′) of the hot-air sources are rapidly switched off and moved back from the path of the packagings being sealed.

7. Apparatus according to claim 4, in which in the space between the guide slots of the said belts (1, 1′), the said vertical bodies (2, 2′) are provided with additional straight slots (4, 4′), parallel with the said guide slots, in which there are housed, directly or via intermediate channels (5) of material with a high degree of thermal insulation, and also with supporting functions, the active straight runs of the tubular electrical resistors (6, 6′) which generate the jets of hot air and which are attached at each end to the backs of the said vertical bodies (2, 2′), for connection to the terminals (7, 7′) of the electrical power and control circuit and for connection to the compressed-air sources (Z. Z′).

8. Apparatus according to claim 5, in which upstream and downstream of the bodies (2, 2′) supporting the electrical resistors (6, 6′) are thermal-insulation barriers (9, 9′) for the protection of components adjacent to the said electrical resistors.

9. Apparatus according to claim 2, in which the said belts (1, 1′) continue for a suitable distance beyond the electrical heating resistors (6, 6′), and those parts of the belts which are not in contact with the sealed packaging pass over cooling units consisting for example of chambers (10, 10′) connected to a source supplying compressed air, either chilled or at room temperature, these chambers having small holes or apertures (11, 11′) for dispensing jets of air onto the sealed parts of the packaging and optionally also onto the said belts.

10. Apparatus according to claim 2, in which the deflection axes (101, 101′) of the final ends of the said belts (1, 1′) are located immediately downstream of the electrical sealing resistors (6, 6′) and around these axes pass belts (12, 12′), preferably having a PTFE-based material, forming part of additional conveyors (T2, T2′) whose purpose is to contact the sealed parts of the packaging, these latter conveyors travelling around final, optionally also motorized, axes (13, 13′), of which the parts not in contact with the packagings pass over cooling stations of any suitable type, for example of the type (10, 10′) that dispenses jets of compressed air, either chilled or at room temperature.

11. Apparatus according to claim 1, in which the electrical resistors (6, 6′) are connected to a supply and control unit (14), optionally designed to select which resistors to activate on the basis of the dimensions of the packaging to be sealed.

12. Apparatus according to claim 1, characterized in that it comprises means which, when the dimensions of the packagings to be sealed vary, enable the distance between the conveyors (T1, T1′, T2, T2′) to be adjusted and optionally the relative heights of these conveyors and of the intermediate horizontal conveyor (T) to be varied so that the folded-down side flaps of the packagings are always correctly positioned relative to the sealing and cooling members of the said apparatus.

13. Apparatus according to claim 1, characterized in that the vertical-axis conveyors (T1, T1′) are made of heat-resistant nonstick mesh webs (100, 100′) and their active runs pass first over the hot-air sources (6, 6′) and then over the cooling units (10, 10′).
